(19) United States
(12) Patent Application Publication
(10) Pub. No.: US 2009/0164465 A1
(43) Pub. Date: Jun. 25, 2009

(54) IMAGE SEARCH SYSTEM, IMAGE SEARCH APPARATUS, AND COMPUTER READABLE MEDIUM

(75) Inventor: Takahiro KOYAMA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/129,407

(22) Filed: May 29, 2008

(30) Foreign Application Priority Data
Dec. 21, 2007 (JP) 2007-329699

(51) Int. Cl. G06F 17/30

(52) U.S. Cl. 707/6; 707/E17.14; 707/E17.019

(57) ABSTRACT

An image search system includes: a storage that stores a plurality of images; a first identification unit that identifies a deteriorated status of a key image used for a search; and a search processing unit that searches the images stored in the storage for a target image corresponding to the key image while referring to a deteriorated status of the key image identified by the first identification unit, and comparing the key image with the images stored in the storage.

### CROSS-REFERENCE TO RELATED APPLICATIONS

This application is based on and claims priority under 35 U.S.C. 119 from Japanese Patent Application No. 2007-329699 filed Dec. 21, 2007.

### BACKGROUND

1. Technical Field

The present invention relates to an image search system, an image search program for searching for a desired image among a plurality of registered images (stored images), and a computer readable medium.

2. Related Art

Search systems are employed in a number of fields, to search for desired images, such as ones that are identical to, or similar to, designated key images, by scanning multiple images that are stored on portable storage media, such as CD-ROMs, DVD-ROMs or memory cards, or on large capacity storage media, such as hard disks or optical disks.

### SUMMARY

According to a first aspect of the present invention, an image search system includes: a storage that stores a plurality of images; a first identification unit that identifies a deteriorated status of a key image used for a search; and a search processing unit that searches the images stored in the storage for a target image corresponding to the key image while referring to a deteriorated status of the key image identified by the first identification unit, and comparing the key image with the images stored in the storage.

### BRIEF DESCRIPTION OF THE DRAWINGS

Exemplary embodiment of the present invention will be described in detail based on the following figures, wherein:

FIG. 1 is a diagram illustrating an example configuration for a document processing, history management system that includes an image search system according to a first embodiment of the present invention;

FIG. 2 is a diagram illustrating a first example arrangement for the document processing, history management apparatus;

FIG. 3 is a diagram illustrating a second example arrangement for the document processing, history management apparatus;

FIG. 4 is a diagram illustrating a third example arrangement for the document processing, history management apparatus;

FIG. 5 is a diagram illustrating a fourth example arrangement for the document processing, history management apparatus;

FIG. 6 is a diagram for explaining a difference in search methods employed by the search processors of image search apparatuses in the first to the fourth example arrangements;

FIG. 7 is a diagram illustrating a fifth example arrangement for the document processing, history management apparatus;

FIG. 8 is a diagram illustrating a sixth example arrangement for the document processing, history management apparatus;

FIG. 9 is a diagram illustrating a seventh example arrangement for the document processing, history management apparatus;

FIG. 10 is a diagram illustrating an eighth example arrangement for the document processing, history management apparatus;

FIG. 11 is a diagram for explaining example pairs obtained using search methods (1) to (4) and additional functions (a) to (c);

FIGS. 12A and 12B are diagrams for explaining the feature of the search process performed by the document process history management apparatus 6 (specifically, the image search apparatus 7) of the first embodiment; and

FIG. 13 is a diagram illustrating an example configuration for an image search system according to a second embodiment of the present invention.

### DETAILED DESCRIPTION

The embodiments of the present invention will now be described in detail while referring to drawings.

### System Configuration

### First Embodiment

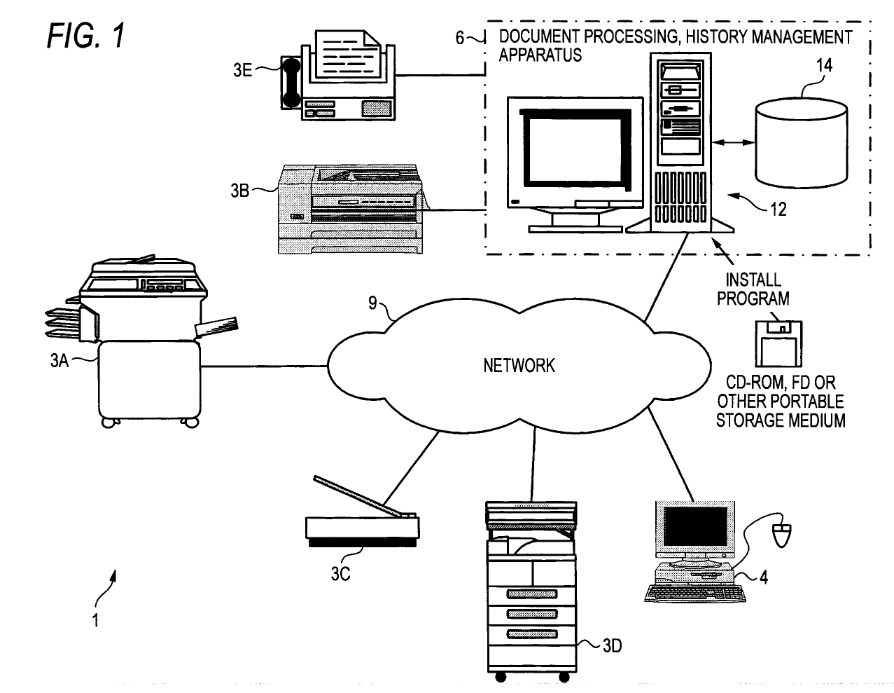

FIG. 1 is a diagram of an example configuration for a document processing history management system wherein an image search system, according to a first embodiment of the present invention, is incorporated. As illustrated in FIG. 1, a document processing, history management system 1 is constituted by: various imaging apparatuses 3 (3A to 3E), each of which has an included image output function, for outputting an image to be reproduced on a printing medium, such as paper, and an included image acquisition function, for reading an image from a printing medium, for example, and obtaining digital data; a process instruction apparatus 4, such as a personal computer, for transmitting image acquisition or output instructions to the imaging apparatuses 3; and a document processing, history management apparatus 6, which has a server function, for recording, saving, managing and searching for document images, and a history function, for preparing processing histories (also termed logs), together with statuses, for document images for which acquisition and output processes are performed by the various imaging apparatuses 3. The imaging apparatuses 3, the process instruction apparatus 4 and the document processing, history management apparatus 6 are connected by a network 9, which is an example communication means.

The document processing, history management system 1 includes: an image search system 2 according to the first embodiment; and a storage section that, when various process operations are performed for a document, stores in or on a predetermined storage medium an operation history that includes an image corresponding to the document that is processed and information designating the corresponding operating status.

The imaging apparatuses 3 are, for example: a copier 3A, which has an image acquisition function and an image output function (collectively called a copying function); a printing apparatus 3B, which is called a printer and which has only a single function (a printing function, an example image output function); an image reading apparatus 3C, which is called a scanner and which has an image acquisition function (specifically called a scanner function); a multifunctional apparatus 3D, which has a printing function, a copying function and a scanner function; and a facsimile machine 3E. The apparatuses 3A to 3E are connected to the document processing, history management apparatus 6 via the network 9 or other predetermined connection interfaces. In FIG. 1, only one imaging apparatus 3 is provided for each type; however, an arbitrary number of apparatuses may be employed, and not all the types may be provided for use.

Assuming that the copier 3A is connected to the document processing, history management apparatus 6 via the network 9, when, for example, a user enters a copy instruction by manipulating the console panel (not shown) of the copier 3A, the copier 3A reads an image (specifically, reads digital data for the image; this also applies to the following explanation) in accordance with the copy instruction, and transmits the image data, via the network 9, to the document processing, history management apparatus 6. Prior to this, however, to authenticate the authority of the user to enter the copy instruction, the copier 3A may request that the user enter a valid user name and password, following which the copier 3A may transmit to the document processing, history management apparatus 6 not only the image data, but also other information, such as the user name, obtained during verification of the user.

Furthermore, the copier 3A does not directly perform a process for reproducing on a paper sheet an image that is read, but receives from the document processing, history management apparatus 6 image data to be used for the image forming process, and employs the received image data to form a corresponding image on a paper sheet. That is, the copier 3A first transmits to the document processing, history management apparatus 6 image data obtained by reading a document to be copied, and then continues the processing based on image data received from the document processing, history management apparatus 6.

The printing apparatus 3B is connected to the document processing, history management apparatus 6 via a serial bus interface, and reproduces an image on a printing medium, such as paper, based on image data received from the document processing, history management apparatus 6.

The image reading apparatus 3C is connected to the document processing, history management apparatus 6 via the network 9, and when a user enters a reading instruction by either manipulating the console panel (not shown) of the image reading apparatus 3C or by operating the process instruction apparatus 4, the image reading apparatus 3C reads an image in accordance with the reading instruction, and transmits the obtained image data to the document processing, history management apparatus 6. At this time, to authenticate the authority of the user who entered the reading instruction, the image reading apparatus 3C may request that the user enter a valid user name and password, and may thereafter transmit to the document processing, history management apparatus 6 not only the image data but also other information, such as the user name, that is obtained during verification of the user.

The multifunctional apparatus 3D is connected to the document processing, history management apparatus 6 via the network 9, and performs the same functions as of the copier 3A, the printing apparatus 3B, the image reading apparatus 3C and the facsimile machine 3E.

The facsimile machine 3E is connected to the document processing, history management apparatus 6 via a serial bus interface. The facsimile machine 3E transmits, via facsimile, image data obtained by scanning, or outputs a facsimile image reproduced on an output medium, such as paper, based on received image data, and outputs to the document processing, history management apparatus 6 an image to be processed for transmission or reception.

The process instruction apparatus 4 is connected to the document processing, history management apparatus 6 via the network 9, and transmits to the document processing, history management apparatus 6 image data for a document to be processed by the printing apparatus 3B and the image reading apparatus 3C and associated information, such as the name of a user who entered a process instruction.

The document processing, history management apparatus 6 includes a server function whereby, upon receiving a request from the process instruction apparatus 4, which is a client system, the imaging apparatus 3 is permitted to perform either the image acquisition process or the image output process; whereby the features of a document image are recorded or saved on a predetermined storage device in order to store, as processing history, a processed image and associated processing information; and whereby stored information is searched for as target information, and the information that is obtained is presented to a user. The same system, as well as various other well known systems, can basically be employed for acquiring and storing processing history and for performing a search.

The document processing, history management apparatus 6 (also an incorporated image search apparatus 7) includes a control unit 12 and a data holding unit 14, which serves as an image database (image DB) that includes, as a storage device, a hard disk device or an optical disk device for storing a processed image and a processing history in correlation. The control unit 12 can employ the same hardware configuration as that for a common computer that includes a CPU (Central Processing Unit) that is a hub for the performance of a control process and of a computation process; and memories, such as RAM (Random Access Memory) and ROM (Read Only Memory), in which processing data and program data are stored. Since this example configuration is a well known configuration that is used for a computer, such as a personal computer, constituted by a micro processor that executes predetermined processing software, the configuration is not shown.

In this embodiment, the arrangement of the control unit 12 that performs the main function, i.e., that performs a process for storing image data for a document and data for operation histories in the data holding unit 14 and for managing these data, or that performs a process used to search through information stored in the data holding unit 14 to find target information (e.g., an image that is identical or similar to an image used as a search key and associated operation information), can be provided not only by using a hardware processing circuit, but also by software, employed by a computer, that is based on program code that performs the above described function.

Therefore, the image search system of this invention can be provided as a software program to be executed by a computer, or as a computer-readable storage medium on which this program is stored. When software is employed to perform the system, operating procedures can be easily changed without alterations of the computer hardware being required.

When software is to be employed to perform the functions for saving, managing and searching for document image data and associated operation history information, a relevant software program, recorded on a recording medium, may be installed, for example, in a computer (a micro-computer) system that includes incorporated special hardware, such as an SOC (System On a Chip), for which a CPU, a logical circuit and a storage device are mounted on a single chip to provide a desired system, or in a general-purpose personal computer that can perform a variety of functions when software programs for the functions are installed.

A recording medium is one for which a status change in energy, such as magnetic, optical or electric energy, is generated in accordance with a description supplied by a program, and using a corresponding signal form, the description supplied by the program is transmitted to a reading apparatus supplied as a hardware resource for a computer. An example recording medium is one that is to be distributed to a user, and is to be separately employed, for a computer, in order to provide a program, e.g., the medium can be a magnetic disk (including a flexible disk FD), an optical disk, such as a CD-ROM (Compact Disc-Read Only Memory), a DVD (Digital Versatile Disc) or an MO (Magneto Optical disk), or a package medium (a portable storage medium), such as a semiconductor memory. A recording medium can also be a ROM or a hard disk on which a program is stored, which is provided for a user, by being incorporated in advance in a computer. Further, a software program may be provided not only via a recording medium, but also via a wire or wireless communication network.

The control unit 12 receives from imaging apparatuses 3, such as the copier 3A and the printing apparatus 3B, image data to be processed and information concerning process operations, such as the name of a user who requested image processing, the processing date and the processing condition, and stores, as processing history data, document image data and associated data (e.g., a document ID, a version and an attribute) in the data holding unit 14. In addition, the control unit 12 transmits received image data to imaging apparatuses 3, such as the copier 3A, the printing apparatus 3B and the facsimile machine 3E, to initiate image processing. Further, the control unit 12 receives an instruction for a search to be performed for processing history information, and performs the search process, i.e., searches the data holding unit 14 for the processing history information, and presents the search results.

In order to perform the search process, when an image is processed by the imaging apparatuses 3, information (an identifier, an ID) that uniquely identifies an image and a version VO are embedded in advance in an output medium (an arbitrary medium, such as paper or a file that holds digital data) by using means such as a barcode, an ID tag or an electronic watermark. When the processed image is to again be processed by the imaging apparatus 3, the ID and the version of the image are supplied. Then, a document image G1 stored in the data holding unit 14, which is designated based on information that is obtained, is compared with a document image G2 that is obtained by reading the output medium (a matching procedure).

A description, obtained for a first point of view and related to the search process, will now be given for the main part of the control unit 12 mechanism that performs the image comparison process for this embodiment. The deteriorated status of an input image I IN, which is a key image for a search process, is employed as a reference, and a search of all the images stored in the data holding unit 14 is performed for a target image that corresponds to the key image (input image I IN). In this manner, the search process is performed more accurately than a search process performed for a target image by comparing the deteriorated input image I IN with registered images I REC. That is, while taking into consideration the deteriorated status of the input image I IN of the document image G2, relative to the original document image, the accuracy with which the search process is performed is the same as that when a comparison is performed using an original document image as a key image. The employment, from the first point of view, of the mechanism will be described later in detail.

Further, a description, from a second point of view, will be given later for the main part of the mechanism of the control unit 12 for this embodiment. The control unit 12 narrows down the range of images to be used for comparison by referring to the time-transient status of the input image I IN, which is the key image for the search process. As a result, the period required for the search process can be reduced, compared with the period that would be required were the target image search process performed by comparing the input image I IN with all the images registered.

In a case wherein a document image G2 is a generated copy that is obtained through repetitive duplication (copying), or has been output (printed), on an output medium, for a considerable period of time (e.g., several years), it is anticipated that the image may have been deteriorated by repetitive copying, the attachment of dust, or the browning of ageing paper. From the second point of view, the mechanism employed performs the search process while taking into account the fact that when such a deteriorated image is used as a search key, it is highly probable that the search accuracy will be reduced and the search period will be extended.

The mechanism employed, from the first point of view, that performs the search process by referring to the deteriorated status of the input image I IN, which is the key image for the search, and the mechanism employed, from the second point of view, that performs the search process by narrowing down the range of images to be compared, while referring to the time-transient status of the input image I IN, which is the key image for the search, are provided from different points of view. The control unit 12 does not necessarily employ perform two mechanisms at the same time, and may employ either mechanism. Of course, it is preferable that the control unit 21 employ both mechanisms.

### (Document Processing, History Management Apparatus: First Example Arrangement)

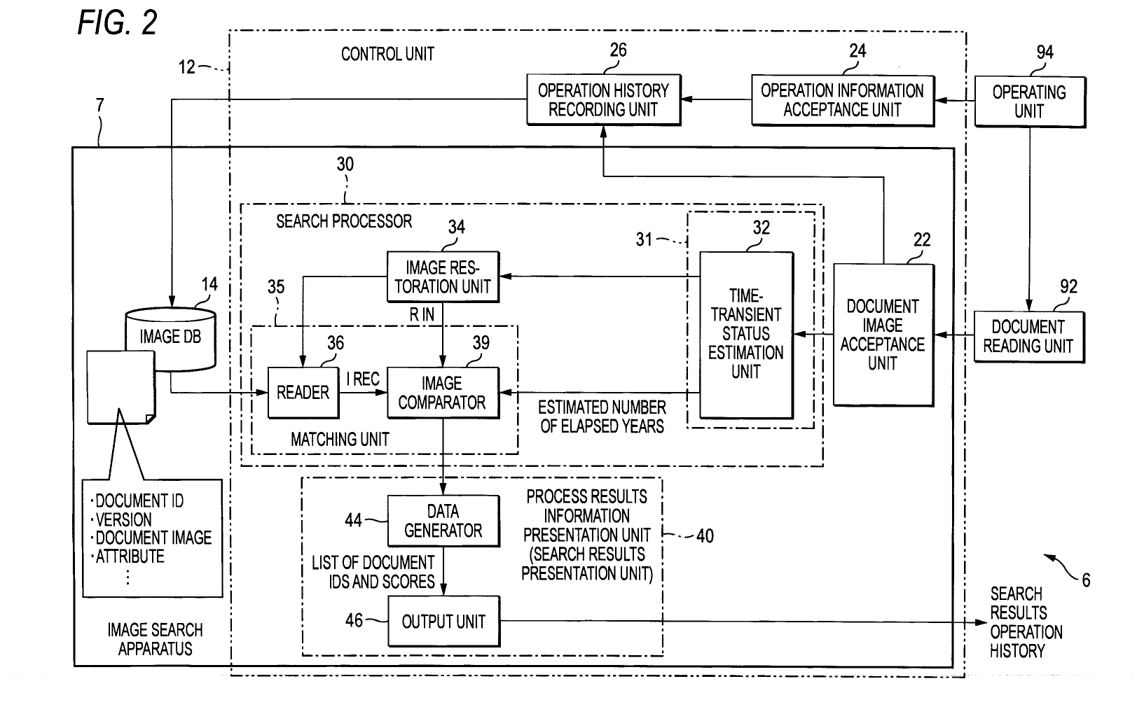

FIG. 2 is a diagram illustrating a first example arrangement for the document processing, history management apparatus 6. The first example arrangement for the document processing, history management apparatus 6 includes: a first image search apparatus 7, provided for the first example arrangement; and a functional section whereby, when various processing operations are to be performed for a document, an image of the document to be processed and information indicating the operating status of the document are collectively stored, as an operation history of the document, in the data holding unit 14.

In this instance, the control unit 12 includes, as the mechanism for performing the above described process and more specifically as a functional block, a document image acceptance unit 22 that receives an processed image from a document reading unit 92 that is mounted, for example, on the copier 3A, the image reading apparatus 3C or the multifunctional apparatus 3D. The document image acceptance unit 22 includes a function unit for obtaining an image that is to be stored, and to be used for image log management, and a key image acceptance unit for receiving an instruction issued to designate a key image to be used for a search process.

A user sets up (places), in a predetermined location on the document reading unit 92, an original image P1, and enters an instruction 01, such as one for the copying, the transmission by fax or the scanning of the original image P1 or for the erasure of the original image P1 using a shredder, in an operating unit 94 (or the process instruction apparatus 4) such as the console panel of the imaging apparatus 3. The document reading unit then reads from the document P1, the image I IN of the document (the original) (specifically called an input image), document identification information (ID) D1 for uniquely specifying the document, and version information V1 for specifying a version.

The control unit 12 also includes: an operation information acceptance unit 24, which receives from an operating unit, such as the console panel of the imaging apparatus 3, information concerning an operation to be performed for a document; and an operation history recording unit 26 that stores, in the data holding unit 14, an operation history that includes an image received by the document image acceptance unit 22, or an image to be stored in consonance with the document image (which images are hereinafter collectively referred to as a registered image I REC), and associated information specifying an operating status. During the storage process, the registered image I REC and the associated information (e.g., a document ID, a version and an attribute) are stored in correlation with each other. The operation information acceptance unit 24 and the operation history recording unit 26 are functional portions that, when various operations are performed for a document, collectively store, as the operation history, the registered image I REC consonant with the document to be processed and the information specifying the operating status in the data holding unit 14.

In addition, the control unit 12 also includes, as a functional portion related to the search control: a search processor 30, which performs a search process by taking into consideration (referring to) the deteriorated status of an input image I IN that is entered as a key image for a search; and a process results information presentation unit 40, which presents various data, based on search results obtained by the search processor 30, to the user.

The search processor 30 of the embodiment can employ, for example, one of the following four methods (1) to (4) to perform the search process by awhile taking into consideration the deteriorated status of an input image I IN that is entered as a key image for a search. For the first example arrangement, the first method (1) is employed.

(1) The input image I IN is restored, by taking image deterioration into consideration, and the restored image R IN that is obtained is compared with the registered image I REC.

(2) Neither the input image I IN nor the registered image I REC is processed, and during the comparison process, matching is performed by taking image deterioration into consideration.

(3) While taking image deterioration into consideration, the registered image I REC is deteriorated to near the level of the input image I IN, and a thus obtained deteriorated image D REC is compared with the input image I IN.

(4) In a case wherein the registered image I REC is also deteriorated, both the input image I IN and the registered image I REC are corrected (restored) by taking image deterioration into consideration, and the restored images (the restored image R IN and the restored image R REC) are then compared.

The search processor 30 of the first example arrangement employs the first search method (1), and the following is the first main part. Instead of employing the document image G2 as a search key image to be directly compared with the document G1, an image for which the condition is as near that of the original document image as possible is restored by taking into consideration the deteriorated status of the document image G2, relative to the original document image, and the restored image (also referred to as the restored image R IN) is employed as a search key image. That is, in a case wherein the input image is deteriorated, a restored image R IN for which the condition is as near that of the original image as possible is generated and used as a search key.

Preferably, during the image restoration process performed by taking status deterioration into consideration, the time-transient status of the image that is output (printed) should be employed as a reference for specifying (estimating) the status deterioration. Further, the second main part is that, during the image search process, the image search range is narrowed down by referring to the time-transient status of the image that is output (printed).

Therefore, the search processor 30 is characterized by the designated the status deterioration for the input image I IN (either by estimating the status deterioration, or by receiving from a user a designated status deterioration), and by restoring an image in consonance with the status deterioration. In addition, provided for the search processor 30 is a functional section for performing a process for specifying the time-transient status of an image that was output to an output medium (or for estimating the time-transient status, or for receiving a user designated time-transient status), for narrowing down the range of search targets in accordance with the time-transient status, and for comparing the restored image R IN with the registered image I REC.

For example, the search processor 30 of the control unit 12 includes a deteriorated/time-transient status specification unit 31 (which serves as both a deteriorated status specification unit and a time-transient status specification unit) that designates the deteriorated status or the time-transient status of the input image I IN. The deteriorated/time-transient status specification unit 31 in the first example arrangement is characterized by estimating both the deteriorated status and the time-transient status of the input image I IN, and also by estimating the time-transient status of the input image I IN, based on the deteriorated status. That is, an arrangement is employed wherein one component serves as a deteriorated status estimation unit and a time-transient status estimation unit.

When an image is deteriorated, it can be assumed that a predetermined time period has elapsed since the image was output, and when the predetermined time period has elapsed since the image was output, it can be assumed that the image is deteriorated. A specific correlation is established between the deteriorated status and the time-transient status, and it can be ascertained that the level (the degree) of a change differs, depending on an environmental condition. Therefore, it can be assumed that the deteriorated status actually indicates the time-transient status or conversely, it can also be assumed that the time-transient status actually indicates the deteriorated status. Thus, substantially, an arrangement may be used wherein a time-transient status specification unit is excluded and only a deteriorated status specification unit is provided, or an arrangement may be employed wherein a deteriorated status specification unit is excluded and only a time-transient status specification unit is provided.

Specifically, the deteriorated/time-transient status specification unit 31 includes: a deteriorated/time-transient status estimation unit 32 (which serves as both a deteriorated status estimation unit and a time-transient status estimation unit) that estimates the deteriorated status of the input image I IN received by the document image acceptance unit 22, and estimates the time-transient status based on the estimated deteriorated status (e.g., estimates the number of years that have elapsed since an image was output to a sheet of paper); and an image restoration unit 34, which employs the deteriorated status estimated by the deteriorated/time-transient status estimation unit 32, and corrects the deterioration of the image to generate a restored image R IN for which the condition is as near that of the original image as possible (i.e., restores an image for which deterioration has been corrected).

The deteriorated/time-transient status estimation unit 32 estimates the deteriorated status of the input image I IN by performing a data analysis for the input image I IN, and also estimates and outputs the number of elapsed years for the input image I IN. To provide an estimated deterioration status and an estimated time-transient status, a common method used in a photographic process can be employed. For example, the yellowish staining of a blank space on the obverse side of a sheet or of the blank reverse side, or the degree of ink fading (for example, reference color data can be printed in advance in a blank space on the obverse side, or on the blank reverse side, and can later be compared with the condition of the ink used for an image) can be specifically employed for an evaluation of the deteriorated status, and the time-transient status can be estimated based on the result of the evaluation performed for the deteriorated status.

The image restoration unit 34 restores an image in accordance with the deteriorated status and the time-transient status that are estimated by the deteriorated/time-transient status estimation unit 32, and outputs a restored image R IN. For the generation of the restored image R IN, a generally employed process for image correction (see, for example, JP-A-2005-316743) can be performed, whereby the luminance and the colors of the deteriorated input image I IN are corrected by referring to the deteriorated status and the number of years that have elapsed, which are estimated by the deteriorated/time-transient status estimation unit 32, by improving the input image I IN until the quality is near that of an original image that is not deteriorated.

The search processor 30 of the control unit 12 also includes a matching unit 35 that searches data stored in the data holding unit 14, using as a key image the restored image R IN generated by the image restoration unit 34, to find an identical or similar image and operation information for that image. The matching unit 35 includes: a reader 36 for reading a registered image I REC from data stored in the data holding unit 14; and an image comparator 39, for comparing the restored image R IN, generated by the image restoration unit 34, with registered images I REC, read by the reader 36, and for using differences between these images for calculating differential information, Diff(G3, IREC).

A method described, for example, in JP-A-11-212993, in JP-A-9-035058 or JP-A-2001-319232, for comparing feature values for individual images, can be employed for image matching.

The image comparator 39 performs image matching, and provides a search result score. The search results score is an indicator used to represent the level (the degree) of a match obtained for two images (in this embodiment, the restored image R IN and the registered image I REC).

At this time, in order to reduce the period required for the search process, instead of referring to all the registered images in the data holding unit 14, which serves as an image DB, the matching unit 35 (specifically, the image comparator 39) narrows down the target image range, until only those registered images in the data holding unit 14 are included for which the years elapsed satisfy the years elapsed count for the input image I IN. Then, the matching unit 35 performs the matching process for the thus obtained images, and outputs an example score list that includes document IDs and differential information Diff. That is, for the individual registered images in the image DB that are selected, the matching unit 35 narrows down the search target range using the number of years elapsed, and performs matching between the registered images I REC, for which the number of years elapsed is satisfied, and the restored image R IN. The search target range may also be narrowed down to include images falling within a specific range extending from before to after the elapsed years. As another method for narrowing down the search target range, the number of years elapsed may be employed to allocate weighted scores, e.g., the weight allocated for an image near the elapsed years may be increased, while the weight allocated for an image farther from the elapsed years may be reduced, and an image for which the total score is equal to or smaller than a predetermined value may be excluded.

Furthermore, the control unit 12 includes: a data generator 44 that, based on the restored image R IN corresponding to the input image I IN and the document identification information D1, generates search results and information concerning the operation history of an image that was searched for (collectively referred to output information); and an output unit 46 that outputs the output data generated by the data generator 44 using sheet paper, by email, or transmission to an output destination such as a facsimile line. The data generator 44 and the output unit 46 constitute a process results, data presentation unit 40 (which serves as a search results presentation unit and an operation history presentation unit) that, upon receiving a search instruction, generates and presents search results information and information related to operation histories for documents to be searched for and other associated documents.

The output information generated by the data generator 44 is, for example, an output image I OUT corresponding to the input image I IN, character information corresponding to the document identification information D1 that specifies a document, and character information that corresponds to version information. The process results, information presentation unit 40 receives a list consisting of pairs of document IDs and scores from the image comparator 39, sorts the pairs in the descending order of the scores, and outputs the paired list as the search results.

That is, according to the image search apparatus 7 in the first example arrangement, the deteriorated/time-transient status estimation unit 32 estimates the number of years elapsed for the input image I IN that is a designated key image to be used for a search, and the image restoration unit 34 restores an image in consonance with the number of years estimated. Then, the image comparator 39 of the search processor 30 performs matching between the input image I IN and the registered images I REC in the data holding unit 14 for which the number of years elapsed is satisfied, and outputs the list of document IDs and scores. Sequentially, the process results information presentation unit 40 sorts the pairs of document IDs and scores in the descending order of the scores, and outputs the paired list as the search results.

For the first example arrangement shown in FIG. 2 and second to fourth example arrangements that will be described later, modifications for which one of three additional functions (a) to (c) is provided can be employed (a detailed explanation will be given for fifth to eighth example arrangements). When an additional function is provided, a functional portion that performs the additional function should be also added to the arrangement. Instead of adding a portion, a functional portion in the first to fourth example arrangements may be removed.

(a) The deteriorated/time-transient status estimation unit 32 is removed, and the time-transient status entered by a user (e.g., the number of years elapsed) is employed by the image restoration unit 34 and the matching unit 35.

(b) A matching method is employed whereby, information concerning a portion that is drastically deteriorated or that has been missed (called deteriorated location information) is received from a user, and a process is performed whereby an image is divided into blocks and matching is performed for the individual blocks.

(c) A user is permitted to enter a deteriorated status (the type or the degree of deterioration), and information concerning the type or the deterioration level entered by the user is employed to perform an image correction process (an image restoration or deterioration process), or a matching process.

### (Document Processing, History Management Apparatus: Second Example Arrangement)

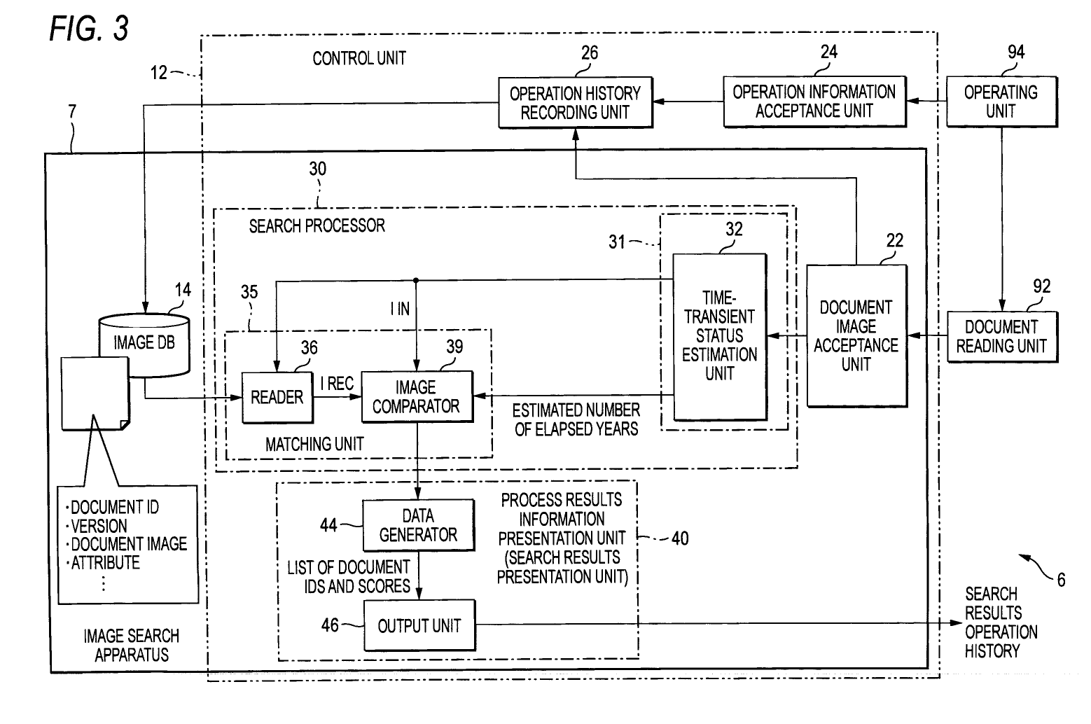

FIG. 3 is a diagram illustrating a second example arrangement for the document processing, history management processing apparatus 6. Since the document processing, history management apparatus 6 in the second example arrangement includes the image search apparatus 7 provided for the second example arrangement, the structure of this the image search apparatus 7 differs from that of the included for the document processing, history management apparatus 6 in the first example arrangement.

The image search apparatus 7 in the second example arrangement is characterized by employing, as a method (a search method) for performing a search process by taking into consideration the deteriorated status of the input image I IN that is entered as a key image to be used for a search, the second search method (2): “Neither the input image I IN nor the registered image I REC is processed, and during the comparison process, matching is performed by taking image deterioration into consideration.” An obvious difference from the first example arrangement is that the image restoration unit 34 is eliminated because the input image I IN and the registered image I REC are not to be processed.

Further, in a process for matching the input image I IN and the registered images I REC, the matching unit 35 (specifically, the image comparator 39) provides a search results score while taking image deterioration into consideration. The image deterioration is specified by employing, as a reference, the time-transient status (e.g., the number of years elapsed) that is estimated by the deteriorated/time-transient status estimation unit 32. According to the second example arrangement, the search results score is an indicator that represents the level (the degree) of a match obtained for the input image I IN and the registered image I REC.

### (Document Processing, History Management Apparatus: Third Example Arrangement)

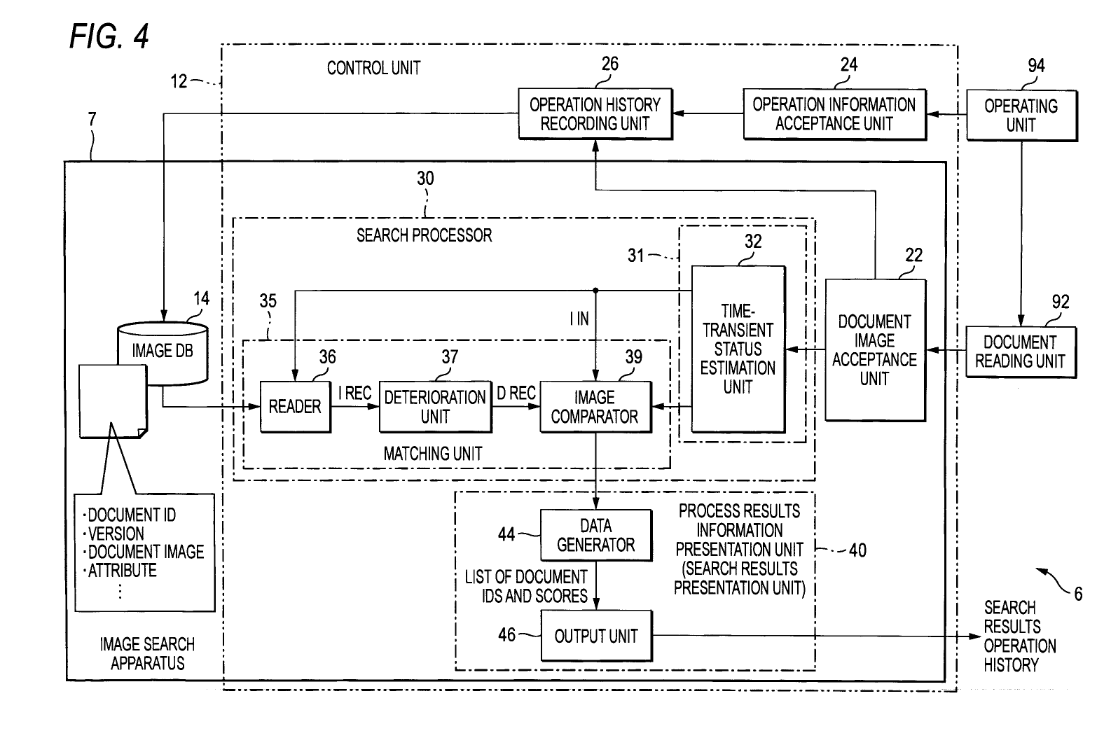

FIG. 4 is a diagram illustrating a third example arrangement for the document processing, history management processing apparatus 6. Since the document processing, history management apparatus 6 in the third example arrangement includes the image search apparatus 7 shown in the third example arrangement, the structure of this image search apparatus 7 differs from that for the document processing, history management apparatus 6 in the first example arrangement.

The image search apparatus 7 in the third example arrangement is characterized by employing, as a method (a search method) for performing a search process by taking into consideration the deteriorated status of the input image I IN, which is entered as a key image to be used for a search, the third search method (3): “While taking into consideration image deterioration, the registered image I REC is deteriorated to near the level of the input image I IN, and the deteriorated image D REC is compared with the input image I IN”. A first difference from the first example configuration is that the image restoration unit 34 is removed because the input image I IN is not to be processed. As a second difference, the matching unit 35 includes a deterioration unit 37, because the registered image I REC is to be deteriorated by taking image deterioration into consideration. When the registered image I REC is read from the data holding unit 14 by the reader 36, the deterioration unit 37 deteriorates the registered image I REC based on the time-transient status that is estimated by the deteriorated/time-transient status estimation unit 32, generates a deteriorated image D REC having an image quality that is as near to that of the input image I IN as possible, and outputs the deteriorated image D REC to the image comparator 39.

Specifically, the deterioration unit 37 intentionally changes an image in consonance with, for example, the number of years elapsed estimated by the deteriorated/time-transient status estimation unit 32, so that the obtained image becomes similar to the input image I IN. Thus, the deteriorated image D REC is output. For generation of the deteriorated image D REC, while referring to the number of elapsed years estimated by the deteriorated/time-transient status estimation unit 32, image correction is performed to intentionally deteriorate the registered image I REC whose luminance and colors are not deteriorated, so that the registered image I REC becomes similar to the input image I IN whose luminance and colors are deteriorated. The direction in which a correction is performed is the reverse of that in which a correction is performed by the image restoration unit 34; however, the basic correction mechanism can be regarded as being the same.

The matching unit 35 (specifically, the image comparator 39) compares the input image I IN with the deteriorated image D REC of the registered image I REC, and provides a search result score. According to the third example arrangement, the search result score is an indicator that represents the level (the degree) of a match between the input image I IN and the deteriorated image D REC.

### (Document Processing, History Management Apparatus: Fourth Example Arrangement)

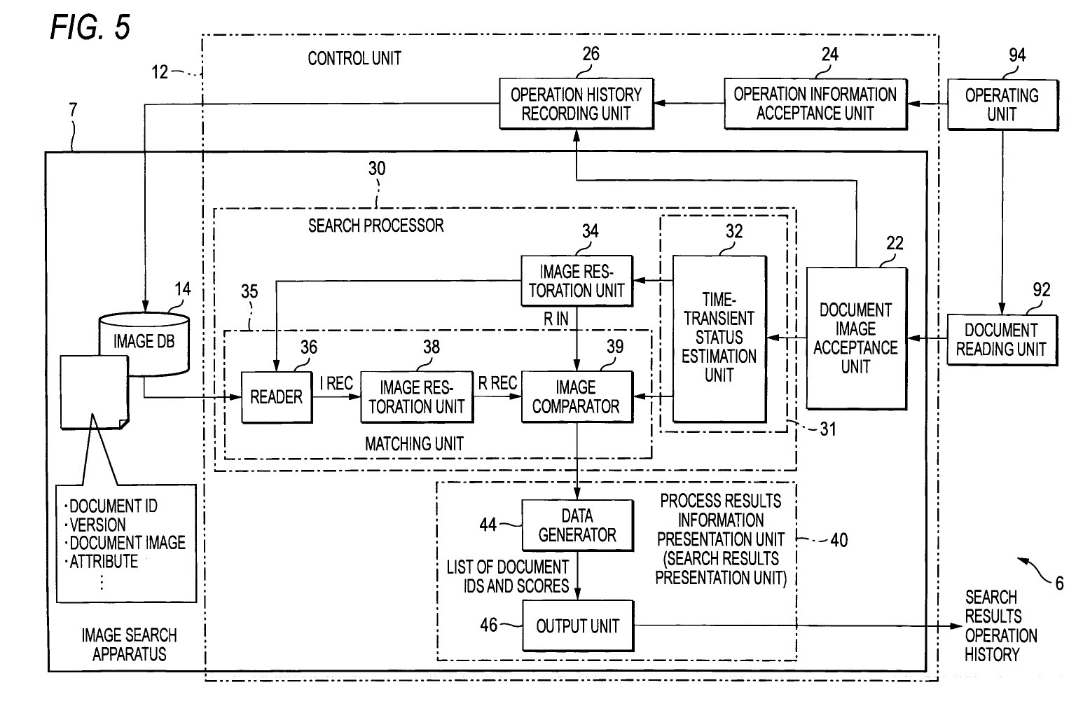

FIG. 5 is a diagram illustrating a fourth example arrangement for the document processing, history management processing apparatus 6. Since the document processing, history management apparatus 6 in the fourth example arrangement includes the image search apparatus 7 shown in the fourth example arrangement, the structure of this image search apparatus 7 differs from that for the document processing, history management apparatus 6 in the first example arrangement.

The image search apparatus 7 in the fourth example arrangement is characterized by employing, as a method (a search method) for performing a search process by taking into consideration the deteriorated status of the input image I IN that is entered as a key image to be used for a search, the fourth search method (4): “In a case wherein the registered image I REC is also deteriorated, both the input image I IN and the registered image I REC are corrected (restored) by taking image deterioration into consideration, and the restored images (the restored image R IN and the restored image R REC) are compared.” An obvious difference from the first example arrangement is that, in addition to the image restoration unit 34 provided for the input image I IN, an image restoration unit 38 is provided as a second image restoration unit. When a registered image I REC is deteriorated, the image restoration unit 38 corrects the registered image I REC based on the deteriorated status of the registered image I REC, and generates a restored image R REC that is as near the original image as possible (i.e., restores an image from which deterioration has been removed). It should be noted that, in the fourth example arrangement, the image restoration unit 34 provided for the input image I IN serves as the first image restoration unit.

As the deteriorated status of the registered image I REC, the number of years elapsed for the registered image I REC is estimated and employed. For the estimation of the number of years elapsed, a common method used in a photographic process can be employed in the same manner as the deteriorated/time-transient status estimation unit 32 to estimate the status of the input image I IN. For example, the yellowish condition of the blank space of the registered image I REC, or the degree of ink fading (for example, reference color data is printed in advance on the blank space and later, is to be compared with the existing condition) is employed to estimate the number of years elapsed. The image deterioration is also taken into consideration when the registered image I REC is restored, so that a case wherein the registered image I REC was obtained by reading a deteriorated image can be coped with.

The matching unit 35 (specifically, the image comparator 39) compares the restored image R IN of the input image I IN with the restored image R REC of the registered image I REC, and provides a search result score. According to the fourth example arrangement, the search result score is an indicator that represents the level (the degree) of a match between the restored image R IN and the restored image R REC.

### (Comparison of Search Methods)

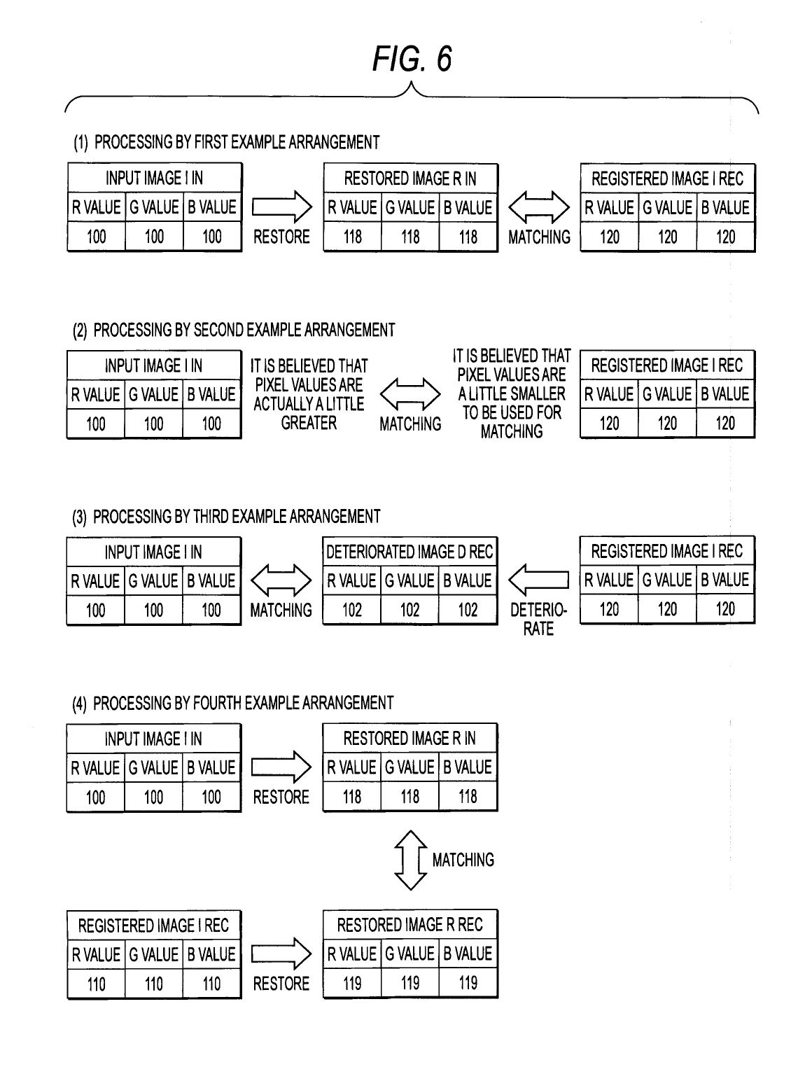

FIG. 6 is a diagram for explaining a difference in the individual search methods employed by the search processors 30 of the document processing, history management apparatuses 6 (especially, the image search apparatuses 7) in the first to the fourth example arrangements. A description will be given by employing an example wherein 100 indicates the levels of the individual R (red), G (green) and B (blue) signals at the pixel positions where the input image I IN is located, and 120 indicates the levels of the individual R (red), G (green) and B (blue) signals at the same pixel positions of the original image (an image of the original before the generation copying is performed).

(1) in FIG. 6 is a diagram for explaining the image correction process for the matching process performed by the search processor 30 of the first example arrangement. In the first example arrangement, while taking image deterioration into consideration, the R value, the G value and the B value of the input image I IN are corrected to R=118, G=118 and B=118, for example, so that the R, G and B values are near those of the original image. Then, the restored image R IN, which is obtained by correcting the R value, G value and B value of the input image I IN, is compared with the registered image I REC.

(2) in FIG. 6 is a diagram for explaining the image correction process for the matching process performed by the search processor 30 of the second example arrangement. A description will be given by employing an example wherein R=120, G=120 and B=120 are the levels of R (red), G (green) and B (blue) signals at the pixel positions (hereinafter referred to as a matching position) of a portion of the registered image I REC that is to be compared and that is read by the reader 36.

According to the second example arrangement, during a comparison process, matching is performed while taking image deterioration into consideration and processing both the input image I IN and the registered image I REC. For example, assume that R=100, G=100 and B=100 are for the input image I IN in the matching position, and when R=120, G=120 and B=120 are at the corresponding pixel positions for the registered image I REC, read by the reader 36. In this case, to perform matching, it is believed that the actual R, G and B values for the input image I IN are a little greater because the input image I IN is deteriorated, or it is believed that R=120, G=120 and B=120 for the registered image I REC, read by the reader 36, should be decreased slightly so a comparison can be performed with the input image I IN. Either this, or the two methods may be employed to perform matching.

(3) in FIG. 6 is a diagram for explaining the image correction process during the matching process performed by the search processor 30 in the third example arrangement. A description will be given by employing an example wherein R=120, G=120 and B=120 are the levels of R (red), G (green) and B (blue) signals at matching positions for of the registered image I REC, read by the reader 36. According to the third example arrangement, while taking image deterioration into account, the R, G and B values of the registered image I REC, read by the reader 36, are intentionally reduced, for example, to R=102, G=102 and B=102, so that the R, G and B values of the registered image I REC are near those of the input image I IN. Then, the deteriorated image D REC, which is obtained by lowering the R, G and B values of the registered image I REC, is compared with the input image I IN.

(4) in FIG. 6 is a diagram for explaining the image correction process during the matching process performed by the search processor 30 in the fourth example arrangement. A description will be given by employing an example wherein R=110, G=110 and B=110 are the levels of R (red), G (green) and B (blue) signals at the matching positions of the registered image I REC, read by the reader 36, and wherein R=120, B=120 and B=120 are the levels of R (red), G (green) and B (blue) signals at the same positions of the original image (the image of the original before generation copying is performed). According to the fourth example arrangement, in a case wherein the registered image I REC as well as the input image I IN is deteriorated, the R, G and B values of the registered image I REC are also corrected, for example, to R=119, G=119 and B=119 by taking image deterioration into consideration, so that the R, G and B values of the registered image I REC are near those of the R, G and B values of the original image. Then, the restored image R IN, obtained by correcting the R, G and B values of the input image I IN, is compared with the restored image R REC, obtained by correcting the R, G and B values of the registered image I REC.

### (Document Processing, History Management Apparatus: Fifth Example Arrangement)

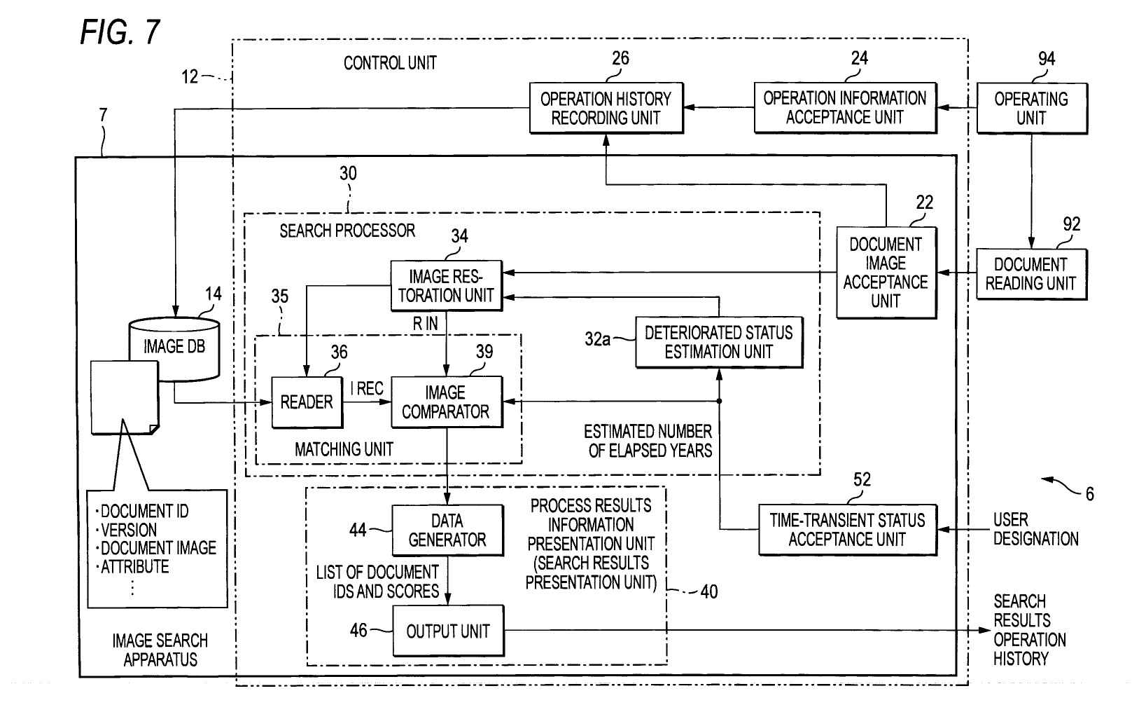

FIG. 7 is a diagram illustrating a fifth example arrangement for the document processing, history management apparatus 6. The document processing, history management apparatus 6 in the fifth example arrangement includes an image search apparatus 7 provided for the fifth example arrangement. The fifth example arrangement and the sixth to eighth example arrangements, which will be described later, are characterized in that a function (one of, or an arbitrary number of functions from (a) to (c)) explained at the end of the first example arrangement is additionally provided for either the first to fourth example arrangements. The fifth example arrangement has a feature whereby at least the first additional function (a) is employed. Referring to the example in FIG. 7, the fifth example arrangement is illustrated by providing only the first additional function (a) for the first example arrangement.

As illustrated in FIG. 7, for the document processing, history management apparatus 6 (specifically, the image search apparatus 7) of the fifth example arrangement, first, the deteriorated/time-transient status estimation unit 32 is eliminated from the search processor 30. Instead, the image search apparatus 7 includes, as an example time-transient status specification unit, the time-transient acceptance unit 52 for receiving a time-transient status (e.g., the number of elapsed years) designated by a user. Information that is received by the time-transient acceptance unit 52, designating the time-transient status, is employed by the image restoration unit 34 and the matching unit 35. This process should be suitable for performance when a user searches for and reprints an original image based on a deteriorated image that was previously output by a printer. In this case, since the user knows the number of elapsed years (and the output device that was used), the user enters this information through the time-transient acceptance unit 52.

In order to permit the image restoration unit 34 to employ information that indicates the time-transient status, a deteriorated status estimation unit 32a is provided as an example deteriorated status specification unit. The deteriorated status estimation unit 32a estimates the deteriorated status of the input image I IN based on the time-transient status information that is received by the time-transient status acceptance unit 52, and the image restoration unit 34 restores the image in accordance with the deteriorated status estimated by the deteriorated status estimation unit 32a. The function of the deteriorated status estimation unit 32a may be included in the image restoration unit 34. The time-transient status can actually be regarded as the deteriorated status, and an arrangement without the deteriorated status estimation unit 32a is also available.

A method generally employed in the photographic process can be used for an estimation of the deteriorated status, based on the time-transient status that is designated by a user. For example, the number of elapsed years and the deterioration condition of an image are correlated in advance, and the estimated number of elapsed years is employed to estimate image deterioration (e.g., the degree of ink fading).

The image restoration unit 34 and the image comparator 39 perform processing based on the time-transient status (the designated number of elapsed years) that the user knows, instead of the time-transient status (the estimated number of elapsed years) that is estimated by the deteriorated/time-transient status estimation unit 32 in the first example arrangement. Since image restoration and matching are performed by referring to the designated number of elapsed years, instead of the estimated number of elapsed years, the accuracy of the restoration of the key image can be increased, compared with that in the first example arrangement. In addition, the image comparator 39 can narrow down the search target range using the number of elapsed years that is designated in consonance with the actual situation.

It should be noted that the first example arrangement having the additional function (a) has been employed to provide the fifth example arrangement in FIG. 7. However, when the third example arrangement having the function (a) is employed, time-transient status information received by the time-transient status acceptance unit 52 can be employed by the deterioration unit 37. And when the fourth example arrangement having the function (a) can be employed, such information is processed by the image restoration unit 38. In either case, the accuracy of the image correction is improved, compared with the other example arrangements.

### (Document Processing, History Management Apparatus: Sixth Example Arrangement)

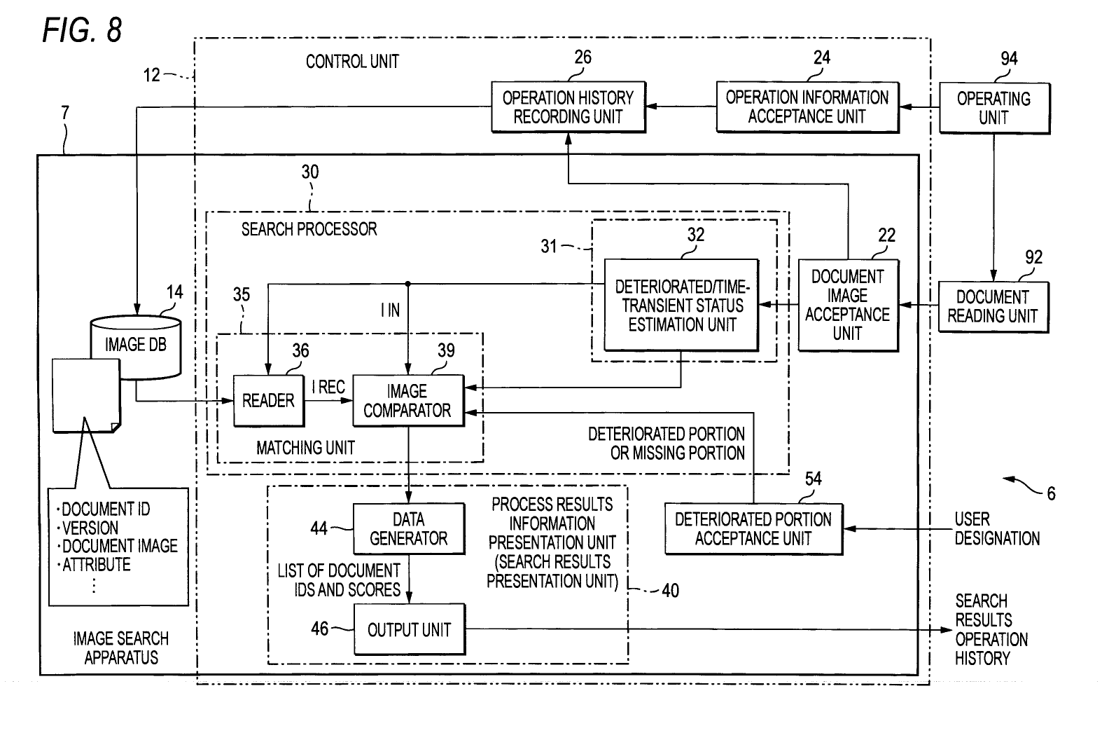

FIG. 8 is a diagram illustrating a sixth example arrangement for the document processing, history management apparatus 6. The document processing, history management apparatus 6 in the sixth example arrangement includes an image search apparatus 7 provided for the sixth example arrangement. The sixth example arrangement is characterized in that a function (one of, or an arbitrary number of functions from (a) to (c)) explained at the end of the first example arrangement is additionally provided for either of the first to fourth example arrangements, and is specifically characterized in that at the least the second additional function (b) is employed. Referring to the example in FIG. 8, the sixth example arrangement is illustrated by providing only the second additional function (b) for the second example arrangement.

As shown in FIG. 8, the document processing, history management apparatus 6 (specifically, the image search apparatus 7) of the fifth example arrangement includes a deteriorated portion acceptance unit 54 that receives, from a user, information (called deteriorated portion information) related to a drastically deteriorated portion or a missing portion, and the deteriorated portion information received by the deteriorated portion acceptance unit 54 is employed by the matching unit 35. This process is suitable for performance by a comparison system whereby an image is divided into blocks and matching is performed for the individual blocks.

For the sixth example arrangement, a deterioration status specification unit is constituted by the deteriorated status estimation portion of the deteriorated/time-transient status estimation unit 32 and the deteriorated portion acceptance unit 54. Since deteriorated portion information related to the deteriorated status of the input image I IN is entered by a user through the deteriorated portion acceptance unit 54, the deteriorated status estimation function of the deteriorated/time-transient status estimation unit 32 simply estimates the type or the degree of deterioration, rather than the deteriorated portion.

Further, the image comparator 39, for example, omits (skips) score calculation for a block that corresponds to information (deteriorated portion information), entered by a user, that indicates a drastically deteriorated portion or a missing portion. Therefore, compared with the second example arrangement, the search accuracy is improved and the search process period is shortened.

It should be noted that the second example arrangement having the function (b) has been employed to provide the sixth example arrangement. However, when the first example arrangement having the function (b) is employed, deteriorated portion information received by the deteriorated portion acceptance unit 54 can be employed by the image restoration unit 34. And when the third example arrangement having the function (b) is employed, such information can be employed by the deterioration unit 37. Further, when the fourth example arrangement having the function (b) is employed, the information can be employed by the image restoration unit 38. And in any case, the accuracy of the image correction is improved, compared with the other example arrangements.

For example, when the first example arrangement having the function (b) is employed, the image restoration unit 34 varies a correction level for an individual block, i.e., increases the correction level for a block that corresponds to information (deteriorated portion information), entered by a user, that indicates a drastically deteriorated portion or a missing portion. Also for the other example arrangements, the image restoration unit 34 varies a correction level for an individual block, and employs a correction level, differing from those of the other portions, to correct an indicated block in the deteriorated portion information.

### (Document Processing, History Management Apparatus: Seventh Example Arrangement)

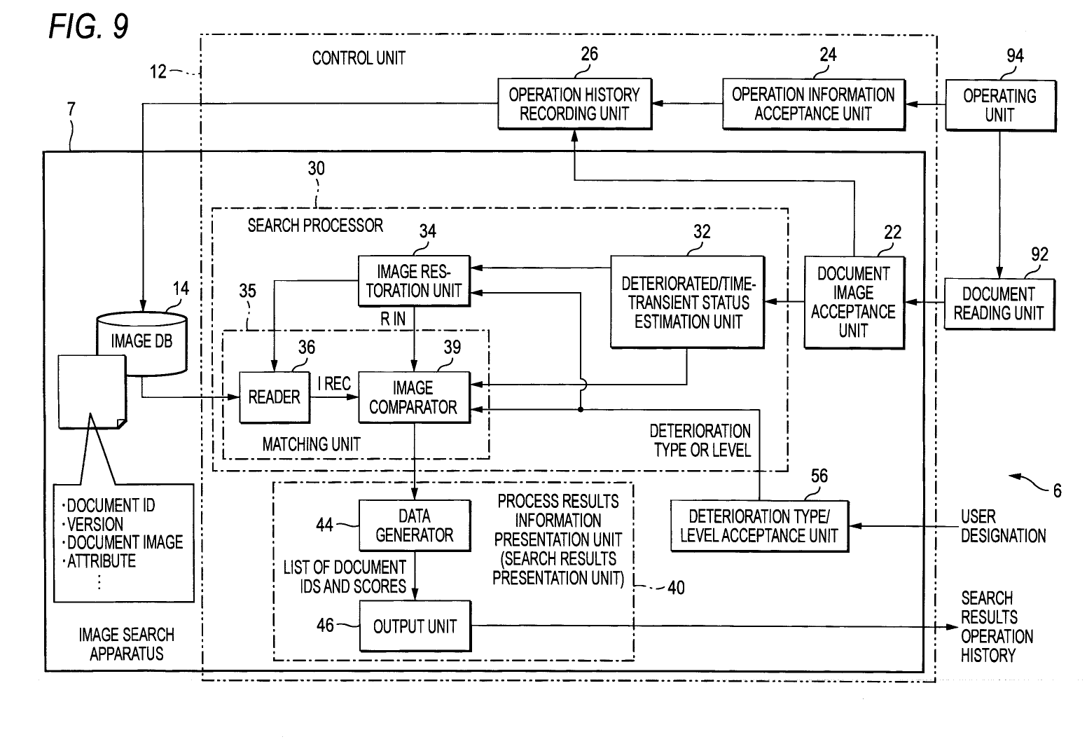

FIG. 9 is a diagram illustrating a seventh example arrangement for the document processing, history management apparatus 6. The document processing, history management apparatus 6 in the seventh example arrangement includes an image search apparatus 7 provided for the seventh example arrangement. The seventh example arrangement is characterized in that a function (one of, or an arbitrary number of functions from (a) to (c)) explained at the end of the first example arrangement is additionally provided for either the first to fourth example arrangements, and is specifically characterized in that at the least the third additional function (c) is employed. Referring to the example in FIG. 9, the seventh example arrangement is illustrated by providing only the third additional function (c) for the first example arrangement.

As illustrated in FIG. 9, the document processing, history management apparatus 6 (especially, the image search apparatus 7) of the seventh example arrangement includes: a deterioration type/level acceptance unit 56, which receives a deterioration condition (specifically, the type and the level of deterioration) from a user. Information concerning the deterioration type and level, received by the deterioration type/level acceptance unit 56, is employed by the image restoration unit 34 and the matching unit 35. This process is suitable for performance when a user employs input information for the deterioration type and level to perform a correction (or a restoration in the first example arrangement having the function (c)) or a comparison of images.

In the seventh example arrangement, the deteriorated status specification unit is constituted by the deteriorated status estimation function of the deteriorated/time-transient status estimation unit 32 and the deterioration type/level acceptance unit 56. Since the deterioration type and level information related to the deteriorated status of the input image I IN is designated by the user through the deterioration type/level acceptance unit 56, the deteriorated status estimation function of the deteriorated/time-transient estimation unit 32 simply performs an estimation for a deteriorated portion, rather than the deterioration type or level that is entered by the user.

The image restoration unit 34 performs image restoration using information, entered by a user, that indicates a deterioration type (e.g., the deterioration of colors, the lack of colors, the deterioration of edges or the damage caused by noise) and a deterioration level. As a result, compared with the first example arrangement, the accuracy with which a key image is restored is increased.

Further, the image comparator 39 performs image matching using the information, entered by the user, that indicates a deterioration type (e.g., the deterioration of colors, the lack of colors, the deterioration of edges or the damage caused by noise) and a deterioration level. As a result, compared with the first example arrangement, the search accuracy is improved, and the search process period is reduced.

It should be noted that the first example arrangement having the function (c) has been employed to provide the seventh example arrangement. However, when the third example arrangement having the function (c) is employed, deteriorated status information received by the deteriorated type/level acceptance unit 56 can be employed by the deterioration unit 37. When the fourth example arrangement having the function (c) is employed, such information can be employed by the image restoration unit 38. In either case, the accuracy with which the image correction is performed is improved, compared with the other example arrangements.

### (Document Processing, History Management Apparatus: Eighth Example Arrangement)

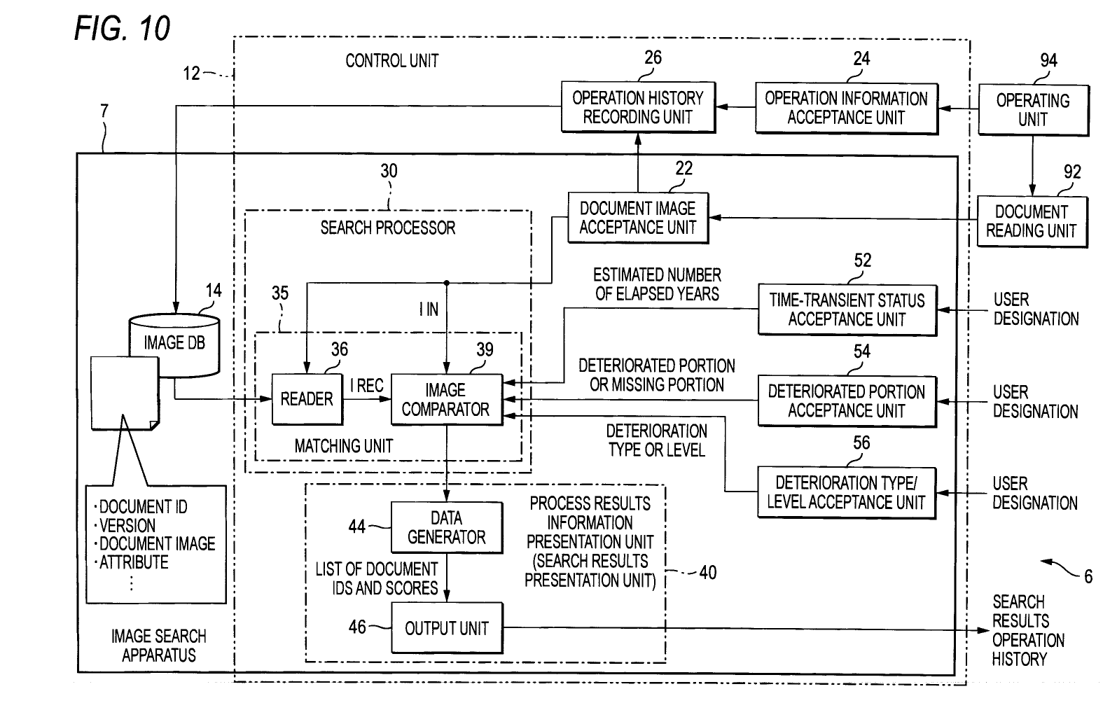

FIG. 10 is a diagram illustrating an eighth example arrangement for the document processing, history management apparatus 6. The document processing, history management apparatus 6 in the eighth example arrangement includes an image search apparatus 7 provided for the eighth example arrangement. The eighth example arrangement is characterized in that a function (one of, or an arbitrary number of functions from (a) to (c) explained at the end of the first example arrangement is additionally provided for either the first to fourth example arrangements. Referring to the example in FIG. 10, the eighth example arrangement is illustrated by providing all of the first to third additional functions (a) to (c) for the second example arrangement. As is apparent from FIG. 10, this arrangement is so designed that the fifth, sixth and seventh example arrangements are assembled with the second example arrangement. For the eighth example arrangement, the time-transient status acceptance unit 52 serves as an example time-transient status specification unit, and the deteriorated portion acceptance unit 54 and the deterioration type/level acceptance unit 56 constitute a deteriorated status specification unit.

### (Example Pairs of Search Methods and Additional Functions)

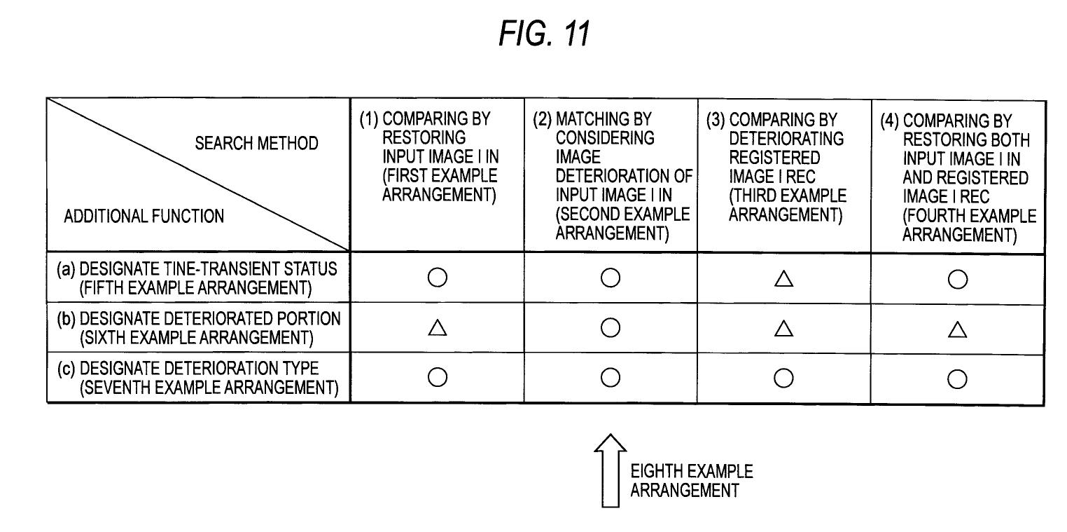

FIG. 11 is a diagram for explaining example pairs obtained through the four types of search methods (1) to (4) described in the first to fourth example arrangements, and the three additional functions (a) to (c) described in the fifth to seventh example arrangements. The eighth example arrangement illustrated in FIG. 11 has been provided by employing the first example configuration having all the first to the third additional functions (a) to (c). However, an arbitrary set can be employed, and as shown in FIG. 11, various arrangements can be obtained.

In FIG. 11, “◯” indicates specifically an especially effective pair, and “Δ” indicates an available pair, although not as effective as a pair indicated by “◯”.

### (Example Search Operation)

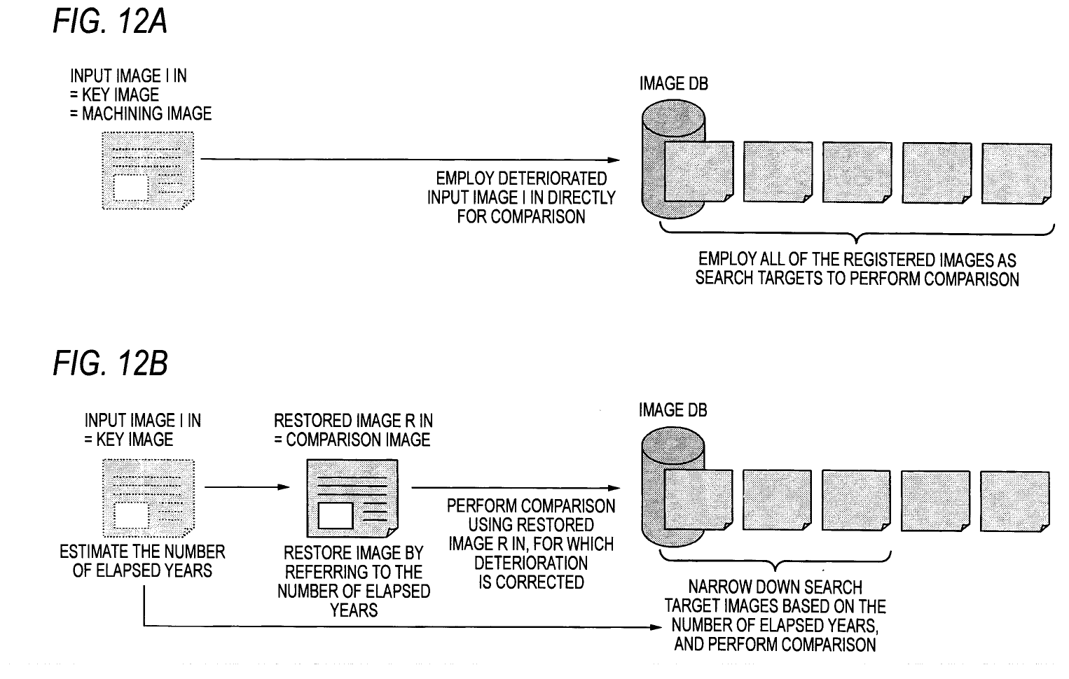

FIGS. 12A and 12B are diagram for explaining the feature of the search processing performed by the document processing, history management apparatus 6 (specifically, the image search apparatus 7) of this embodiment. FIG. 12A is a diagram illustrating an example search operation performed according to a comparison example, and FIG. 12B is a diagram illustrating an example search operation performed by the image search apparatus 7 of the first example arrangement according to this embodiment.

During the search processing performed in the comparison example, as shown in FIG. 12A, an input image I IN is compared with registered images I REC. At this time, when the input image I IN is obtained by reading a generation copy that is formed by repetitive duplication (copying), or when the input image I IN has been output (printed) on an output medium for a considerable period of time (e.g., several years), the image might be deteriorated due to the repetitive copying, or by the attachment of dust or growing a yellowish staining of a sheet.

When the deteriorated input image I IN is directly compared with the registered images I REC, the search accuracy is reduced. Further, when the entire registered images, i.e., all the registered images I REC stored in the data holding unit 14, are employed as search targets to be compared with the input image I IN, a long period is required for the search.

On the other hand, for the search processing of this embodiment, as shown in FIG. 12B, the deteriorated/time-transient status estimation unit 32 estimates the number of elapsed years based on the deteriorated input image I IN that is the search key image, the image restoration unit 34 restores the image by referring to the estimated number of elapsed years, and the matching unit 35 performs matching using the restored image R IN. Since the restored image R IN, for which the deterioration has been corrected, is employed for matching, the search accuracy is increased, compared with the comparison example that directly compares the deteriorated input image I IN with the registered images I REC.

In addition, while referring to the number of elapsed years estimated by the deteriorated/time-transient status estimation unit 32, the matching unit 35 narrows down the search target range for images, and compares these images with the restored image R IN. Since the number of search target images becomes smaller than the total number of registered images I REC stored in the data holding unit 14, the search process period is shorter than the comparison example that employs all the registered images for comparison.

### System Configuration

### Second Embodiment

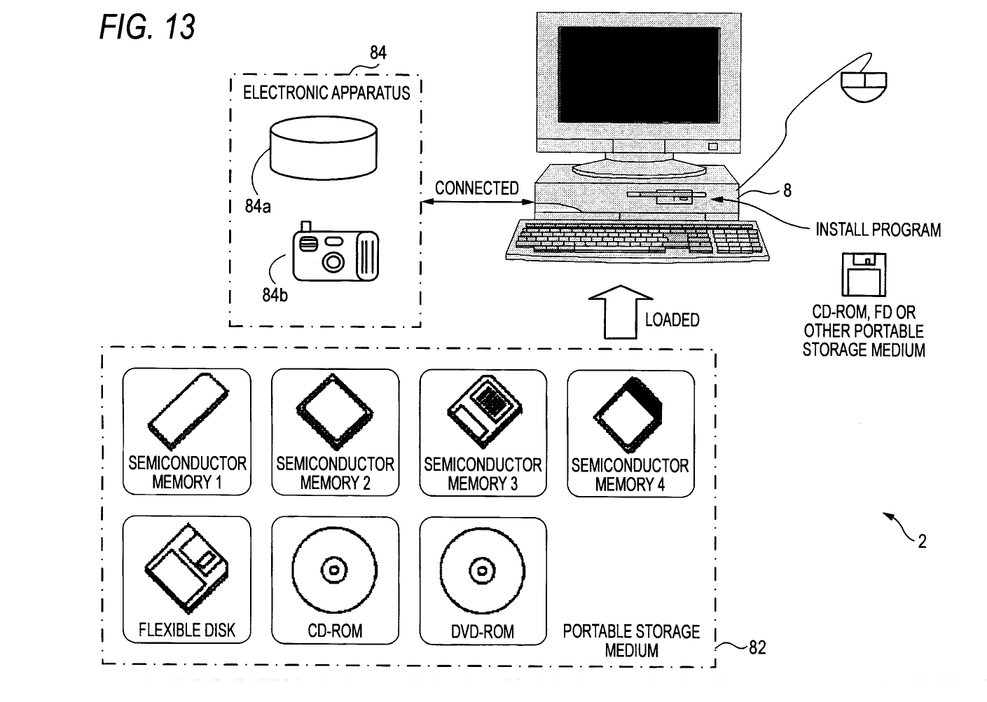

FIG. 13 is a diagram illustrating an example configuration for an image search system according to a second embodiment of the present invention. As shown in FIG. 13, an image search system 2 for the second embodiment is separated from the document processing, history management apparatus 6, and is appropriate for a system that mainly performs an image search operation. The image search system 2 can be applied for a case wherein, for example, a standalone computer 8 is employed as an image search apparatus 7 and multiple registered images that the computer 8 can handle are to be searched to find a desired image.

The first to the eighth example arrangements described in the first embodiment or the other example arrangements shown in FIG. 10 can be employed for the functional arrangement of the image search apparatus 7 for the second embodiment.

Registered images used as search targets can, for example, be images to be stored in a storage device (not shown) incorporated in the computer 8, images recorded on a portable storage medium 82, such as a flexible disk FD, a CD-ROM, a DVD-ROM or in semiconductor memories having various specifications (in FIG. 13, semiconductor memories 1 to 4 of four different types), or images stored in an electronic apparatus 84 (an external storage device 84a or a semiconductor memory mounted on a digital camera 84b) that is connected to the computer 8 by employing a predetermined method (e.g., a USB (Universal Serial Bus)).

The image search apparatus 7 of the image search system 2, as well as in the first embodiment, includes a control unit 12. The control unit 12 can employ the same hardware configuration as that for a common computer that includes a CPU, which is a hub for performing a control process and a computation process; and memories, such as RAM and ROM, in which process data and program data are stored. Since this example hardware configuration is well known as the configuration of a computer, such as a personal computer, constituted by a micro processor that executes predetermined processing software, the configuration is not shown.

In the second embodiment, the arrangement of the control unit 12 that performs the main function, i.e., that performs a search process to find a target image (e.g., an image identical or similar to a search key image) in image data stored in a predetermined storage medium, can be provided not only using a hardware processing circuit, but also by software provided using a computer based on program code that performs the above described function.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image search system comprising:
a storage that stores a plurality of images;
a first identification unit that identifies a deteriorated status of a key image used for a search; and
a search processing unit that searches the images stored in the storage for a target image corresponding to the key image while referring to a deteriorated status of the key image identified by the first identification unit, and comparing the key image with the images stored in the storage.

2. An image search apparatus comprising:
a first identification unit that identifies a deteriorated status of a key image used for a search; and
a search processing unit that searches a plurality of images stored in a storage for a target image corresponding to the key image while referring to a deteriorated status of the key image identified by the first identification unit, and comparing the key image with images stored in the storage.

3. The image search apparatus as claimed in claim 2, further comprising:
a second identification unit that identifies a time-transient status of a key image that is output to an output medium,
wherein
the search process unit narrows down the range of the images used for comparison by limiting the number of the images stored in the storage while referring to the time-transient status identified by the second identification unit.

4. The image search apparatus as claimed in claim 2, further comprising:
a restoration unit that restores an image that is less deteriorated by correcting a deterioration of the key image based on the deteriorated status of the key image identified by the first identification unit,
wherein
the search processing unit compares, with the images stored in the storage, the image that is restored by the restoration unit based on the key image.

5. The image search apparatus as claimed in claim 2,
wherein
the search processing unit directly compares the key image with images stored in the storage while referring to the deteriorated status of the key image identified by the first identification unit.

6. The image search apparatus as claimed in claim 2, further comprising:
a deterioration unit that, based on the deteriorated status of the key image identified by the first identification unit, deteriorates images that are stored in the storage that are being used for comparison, so that quality of the images nears that of the key image,
wherein
the search processing unit compares the key image with the images stored in the storage, the images being deteriorated by the deterioration unit.

7. The image search apparatus as claimed in claim 2, further comprising:
a first restoration unit that, based on the deteriorated status of the key image identified by the first identification unit, corrects deterioration of the key image, and restores an image that is less deteriorated; and
a second restoration unit that, based on the deteriorated statuses of the images that are stored in the storage that are being used for comparison, corrects the deterioration of the images being used for comparison, and restores images that are less deteriorated,
wherein
the search processing unit compares, with the restored images of the images used for comparisons by the second restoration unit, the image that is restored for the key image by the first restoration unit.

8. The image search apparatus as claimed in claim 2,
wherein
the first identification unit comprises:
a deteriorated status estimation unit that performs a data analysis of the key image to estimate the deteriorated status of the key image.

9. The image search apparatus as claimed in claim 2, further comprising:
a time-transient status acceptance unit that accepts a user instruction to designate a time-transient status for a key image that is output to an output medium,
wherein
the first identification unit comprises:
a deteriorated status estimation unit that estimates the state of the deterioration of the key image based on the time-transient status of the key image received by the time-transient status acceptance unit.

10. The image search apparatus as claimed in claim 2,
wherein
the first identification unit comprises:
an acceptance unit that accepts a user instruction for designating at least one location on the key image where deterioration occurs, a deterioration type and a deterioration degree; and
an estimation unit that employs a predetermined method for estimating a location on the key image where deterioration occurs, a deterioration type and a deterioration degree that is not designated by a user instruction.

11. The image search apparatus as claimed in claim 3, further comprising:
a time-transient estimation unit that performs a data analysis to prepare a time-transient status estimation for the key image.

12. The image search apparatus as claimed in claim 3,
wherein
the time-transient estimation unit comprises:
a time-transient status acceptance unit that accepts a user instruction to designate a time-transient status for the key image that is output on an output medium.

13. An image search system comprising:
a storage that stores a plurality of images;
a first identification unit that identifies a time-transient status of a key image, that is output on a output medium; and
a search processing unit that, while referring to the time-transient status of the key image identified by the first identification unit, narrows down a range of the images stored in the storage to obtain a reduced number of images, and compares the reduced number of images with the key image, so that all the images stored in the storage are searched for a targeted image corresponding to the key image.

14. An image search apparatus comprising:
a first identification unit that identifies a time-transient status of a key image, that is output on a output medium; and
a search processing unit that, while referring to the time-transient status of the key image identified by the first identification unit, narrows down a range of the images stored in a storage storing a plurality of images to obtain a reduced number of images, and that searches all the images stored in the storage for a targeted image corresponding to the key image by comparing the reduced number of images with the key image.

15. A computer readable medium storing a program causing a computer to execute a process for performing a search process during which stored images are searched for a target image, the process comprising:
accepting a designation of a key image used for a search;
identifying a deteriorated status of the key image accepted by the key image acceptance unit; and
searching all the stored images for a target image that corresponds to the key image by referring to the deteriorated status identified of the key image and comparing the key image with stored images.

16. A computer readable medium storing a program causing a computer to execute a process for performing a search process during which stored images are searched for a target image, the process comprising:
accepting a designation of a key image to be used for a search;
identifying a time-transient status of the key image, accepted by the key image acceptance unit, following output of the key image on an output medium;
performing a process, for all stored images by referring to the time-transient status identified, that sets and applies a selection qualifier satisfied by the statuses of a reduced number of images; and
searching all the stored images for a target image that corresponds to the key image by referring to the time-transient status identified of the key image, narrowing down a range of the stored images to obtain a reduced number of images, and comparing the reduced number of images with the key image.
